(19) United States
(12) Patent Application Publication
(10) Pub. No.: US 2024/0415732 A1
(43) Pub. Date: Dec. 19, 2024

(54) DEVICE FOR A SAUNA STOVE AND SAUNA STOVE

(71) Applicant: Klafs GmbH, Schwäbisch Hall (DE)

(72) Inventor: Markus Gäbele, Schwäbisch Hall (DE)

(21) Appl. No.: 18/234,666

(22) Filed: Aug. 16, 2023

(30) Foreign Application Priority Data
Jun. 15, 2023 (EP) 23179460.3

(51) Int. Cl. A61H 33/06; A61H 33/00

(52) U.S. Cl. CPC A61H 33/063; A61H 33/005; A61H 33/065; A61H 2033/0058; A61H 2033/061; A61H 2201/0207; A61H 2201/0257; A61H 2201/1238; A61H 2201/5048

(57) ABSTRACT

The device is configured to distribute air, which is heated by the sauna stove above a housing of that contains a heating device and includes at least one fan. The device includes an air duct with at least one inlet opening below the housing and at least one outlet opening above a discharge opening. The heated air exits the housing through the discharge opening in which a bed of stones is arranged. The air duct and the fan are configured such that the fan draws air into the inlet opening, then transports the air upwards in the air duct along the sauna stove to the at least one outlet opening, and blows the air out of the outlet opening above the discharge opening of the housing. A flow alignment component is arranged at the outlet opening and is configured such that a direction of flow of the air is adjustable.

### CROSS-REFERENCE TO RELATED APPLICATION

This application claims priority to and the benefit of European Patent Application No. 23 179 460.3, filed on Jun. 15, 2023, and entitled “DEVICE FOR A SAUNA STOVE AND SAUNA STOVE,” which is herein incorporated by reference.

### BACKGROUND

### 1. Field

The present disclosure relates to a device for a sauna stove and to a sauna stove. The device is configured to distribute air, which is heated by the sauna stove above a housing of the sauna stove containing a heating device of the sauna stove, in a targeted manner in the sauna room. The device includes at least one fan.

### 2. Related Art

EP 2 092 926 A1 teaches a device with a swiveling fan which is arranged at a swiveling boom at a distance above the housing of the sauna stove. The swiveling fan is volume flow-controlled, and the direction of flow can be set via the swiveling arm. The device requires a large installation space and is susceptible to errors since the swivel arm is very exposed and the fan is subjected to very high temperatures. Apart from this, the device only guides an unsatisfactorily small portion of the air heated by the sauna stove into the sauna room leading to an unsatisfactory sauna experience which is not comparable with a manual distribution of the air, for example by a sauna attendant after an infusion.

### SUMMARY

The object of the present disclosure is to provide a device which eliminates the above mentioned disadvantages and can in particular replace a manual distribution of the air, for example after an infusion or instead of an infusion.

The object is achieved by the device including an air duct with at least one inlet opening below the housing and at least one outlet opening above a discharge opening of the housing. The air heated by the heating device exits the housing through the discharge opening and in which preferably a bed of stones is arranged. The air duct and the fan are configured such that the fan draws air into the at least one inlet opening, then transports the air upwards in the air duct along the sauna stove to the at least one outlet opening, and blows the air out of the at least one outlet opening above the discharge opening of the housing of the sauna stove. A flow alignment component is arranged at the outlet opening and is configured such that a direction of flow of the air is adjustable.

By the solution according to the disclosure, the above mentioned disadvantages can be eliminated. The fan is subjected to clearly lower and more constant temperatures, and the air duct guides the air in a targeted manner to the outlet opening which can be placed closer to the discharge opening. Thereby, the air from the outlet opening can carry along clearly more heated air from the housing of the sauna stove and distribute it in the sauna room in a targeted manner through the flow alignment component. Correspondingly, the device according to the disclosure also improves the sauna experience.

In a particularly preferred embodiment of the present disclosure, the direction of flow always has a horizontal component which leads from the outlet opening via the discharge opening of the housing into the sauna room. Thereby, a larger portion of the volume flow of the heated air exiting from the discharge opening can be guided into the sauna room in a targeted manner.

According to a further, particularly preferred embodiment, the at least one outlet opening is arranged at a height of 2 to 20 cm, preferably 4 to 10 cm, particularly preferred 6 to 9 cm above the discharge opening of the housing. With this distance, the heated air exiting from the discharge opening can be particularly efficiently and largely carried along by the air from the device. If a bed of stones is arranged in the discharge opening, the at least one outlet opening is preferably arranged at a height of 1 to 10 cm, preferably 1 to 10 cm, particularly preferred 2 to 6 cm, above a highest point of a bed of stones situated in the discharge opening. The bed of stones here often goes beyond the discharge opening.

In another preferred embodiment, the device is configured such that a volume flow of the air through the air duct is between 50 and 150 m³/h, preferably between 80 and 120 m³/h, particularly preferred 100 m³/h. This permits a preferably efficient and targeted distribution of the heated air in the sauna room.

According to a preferred embodiment, the device includes two outlet openings with one flow alignment component each, wherein the directions of flow from the two outlet openings can be each independently adjusted by the respective flow alignment components. Through two outlet openings with one flow alignment component each, the heated air can be transported to two positions in the sauna room in a targeted manner, and the achieved volume flow per outlet opening is here still within an advantageous range for the sauna experience.

In one preferred embodiment, the flow alignment component is designed such that both a vertical and a horizontal component of the direction of flow can be adjusted. Thereby, the position in the sauna room to which the heated air is to be transported can be exactly adjusted.

According to a particularly preferred embodiment, the flow alignment component includes horizontal louvers and vertical louvers which are mounted to be movable with respect to each other and to the outlet opening. Such flow alignment components permit a precise adjustment of the direction of flow and can moreover be provided in a robust, heat-resistant and relatively inexpensive way.

Preferably, the flow alignment component includes two horizontal louvers arranged one upon the other in parallel which are rigidly connected with each other at their longitudinal ends and are mounted to be rotatable about an axis of rotation parallel to a longitudinal orientation of the horizontal louvers in the outlet opening. The flow alignment component has at least two vertical louvers which are mounted between the horizontal louvers in a swiveling manner and are preferably connected to each other in such a way that, by adjusting one vertical louver, the other vertical louvers are aligned. This design permits a particularly robust and easily adjustable design of the flow alignment component. In this case, the flow alignment component can also be mounted with respect to the outlet opening such that large angles with respect to the horizontal component of the direction of flow are allowed. Particularly preferred, the two horizontal louvers arranged one above the other in parallel are mounted in the outlet opening such that the entire air which passes the air duct is guided between the two horizontal louvers arranged one above the other in parallel. As a result, the entire air which exits from the at least one outlet opening is guided to the desired location.

In a further preferred embodiment, the device has a plastic clip which is attached to one of the vertical louvers to be extendable so that the plastic clip can be grasped and the vertical louvers and horizontal louvers can be moved via the plastic clip. Thereby, the louvers can be made of materials with a high coefficient of heat conduction, and the direction of flow of the air can still be adjusted manually even at elevated temperatures in the sauna room.

According to another preferred embodiment, one of the vertical louvers projects beyond the horizontal louvers and the outlet opening. This allows the user to manipulate the flow alignment component with an infusion ladle or similar component and adjust the alignment.

According to a further preferred embodiment, the at least one fan is arranged at or in the at least one inlet opening. Here, the fan can suck in air from the area below the housing as efficiently as possible. Preferably, the air duct has at least two inlet openings below the sauna stove, and one fan each is arranged at or in the at least two inlet openings. As a result, the device is less susceptible to errors and can be used even if one fan is defective.

According to a further preferred embodiment, a generated volume flow of the at least one fan is adjustable.

In a further preferred embodiment, the device has a noise-cancelling device, which suppresses noise generated by the at least one fan. This can be achieved, among other things, by integrating the fan sounds into a pleasant background noise. This can improve the sauna experience, which is aimed at relaxation.

According to a further preferred embodiment, the device has a suspension at the air duct with which the device can be attached to a first outer wall of the housing of the sauna stove. Thereby, the device can be attached retrospectively to existing sauna stoves.

Furthermore, the present disclosure relates to a sauna stove with a device according to one of the above described embodiments for a sauna room. The device is attached to a first outer wall of a housing of the sauna stove containing a heating device and having a discharge opening from which the air heated by the heating device exits from the housing. Such a sauna stove permits an improved sauna experience as heated air can be guided into the sauna room in a targeted manner and the sauna experience can be intensified thereby. This is also possible without a sauna attendant or manual operation. This is particularly advantageous for sauna users who use the sauna room alone, as they cannot manipulate the heated air and enjoy the sauna experience at the same time.

In a preferred embodiment of the sauna stove according to the disclosure, the latter has a bed of stones which is arranged in the discharge opening, and an automatic infusion device which has a reservoir, a pump and a liquid distribution means which are configured such that liquid from the reservoir is distributed onto the bed of stones by means of the pump and the liquid distribution means. By the combination of the device with an automatic infusion device, the sauna experience can be greatly enhanced, especially for individual users, since a complete infusion ceremony including air manipulation after the moistening of the bed of stones can take place without manual action.

Preferably, the sauna stove includes a voice control by which the pump can be actuated. This allows the infusion to be conveniently started from the sauna user's sitting position. In this case, the amount of the distributed liquid is preferably adjustable by means of the voice control, and further preferred, the device can also be actuated by voice control. Thereby, the sauna stove permits an individualized sauna experience.

In a particularly preferred embodiment, the voice control is set up in such a way that different programs are selectable which contain different amounts of distributed liquid and settings of the device. This makes voice control easy to use.

Also preferably, the sauna stove comprises a control with a manual control interface, preferably with buttons by which the sauna stove can be started. Preferably, the automatic infusion device and the device can be controlled and adjusted via the control interface.

Moreover, the present disclosure relates to a sauna stove for a sauna room with a housing containing a heating device and having a discharge opening from which the air heated by the heating device exits due to convection. The sauna stove has a bed of stones which is arranged in the discharge opening. An automatic infusion device is provided and comprises a reservoir, a pump and a liquid distribution means, which are configured such that by means of the pump and the liquid distribution means, liquid from the reservoir is distributed to the bed of stones. The liquid distribution means consists of a spray plate and a liquid opening. The liquid opening is arranged below the spray plate surrounded by the bed of stones such that liquid from the liquid opening is sprayable against the spray plate from below. The liquid opening is preferably oriented such that the liquid exits from the latter vertically to the top. By using this liquid distribution means, the liquid can be distributed over a large area on the bed of stones. The automatic infusion device moreover only requires little maintenance as, thanks to the arrangement according to the disclosure, no nozzles that tend to fur up have to be used. The water-conducting cross-sections can be formed larger and can be better insulated.

In a preferred embodiment, the pump and the reservoir are arranged separately from the heating elements, and a line leads from the pump through the bed of stones to the liquid opening, wherein the reservoir. The pump and the line are preferably thermally insulated from the heating elements and the bed of stones. As a result, the pump and the reservoir are not exposed to too high temperatures, allowing for a wider range of possible components. By the insulation, less or no water evaporates in the reservoir, the pump, and the line, so that less limescale is deposited and the automatic infusion device is less maintenance-intensive.

According to a further preferred embodiment, a bottom side of the spray plate is curved to the bottom such that the occurring liquid is distributed over at least 30%, preferably at least 50%, of the bed of stones. The bottom side of the spray plate preferably has a honeycomb structure and/or mandrels by which a dripping off of the liquid from the bottom side of the spray plate is caused at predetermined positions over the bed of stones. As a result, the water can be distributed over the bed of stones in a targeted manner, preferably covering all areas, and there is a low risk of water being sprayed outwards or not onto the bed of stones. In addition, the curvature also prevents the lateral spraying of infusion liquid on people in the sauna cabin.

In another preferred embodiment, the pump has a discharge height of at least 15 cm and maximally 45 cm, and the spray plate has a distance between 0.5 cm and 4 cm from the liquid opening. As a result, the water is distributed over the spray plate at sufficient speed and is distributed over a large area over the bed of stones.

In a preferred embodiment, the reservoir has a volume of 0.5 to 2 L. This can ensure that enough liquid can be provided for infusions of at least one sauna session, and that the structure of the sauna stove can still be compact.

In another preferred embodiment, the reservoir is located in a flap in a second outer wall of the housing such that the reservoir can be filled when the flap is open. This makes the handling of the reservoir easy for the user.

In another preferred embodiment, the reservoir is located in a removable infusion tank which is placed in a second outer wall of the housing and is extendable from it. This makes filling the reservoir even easier for the user.

According to a further embodiment, the infusion stove comprises an evaporator unit. This additionally extends the possibilities of using the sauna stove.

### BRIEF DESCRIPTION OF THE DRAWINGS

One embodiment of the present disclosure will be illustrated more in detail below with reference to drawings.

In the drawings:

FIG. 1: shows a diagonal view from above onto an embodiment of a sauna stove with a device and an automatic infusion device and without the representation of the bed of stones,

FIG. 2: shows a side view of the embodiment,

FIG. 3: shows a diagonal view from above onto the device of the embodiment,

FIG. 4: shows a sectional view of the side view of an upper end of the device of the embodiment,

FIG. 5: shows a detailed diagonal view from above onto the embodiment,

FIG. 6: shows a schematic detailed diagonal view from above onto the embodiment with a bed of stones, and

FIG. 7: shows a sectional view of the side view of the outlet opening and the automatic infusion device of the embodiment without bed of stones.

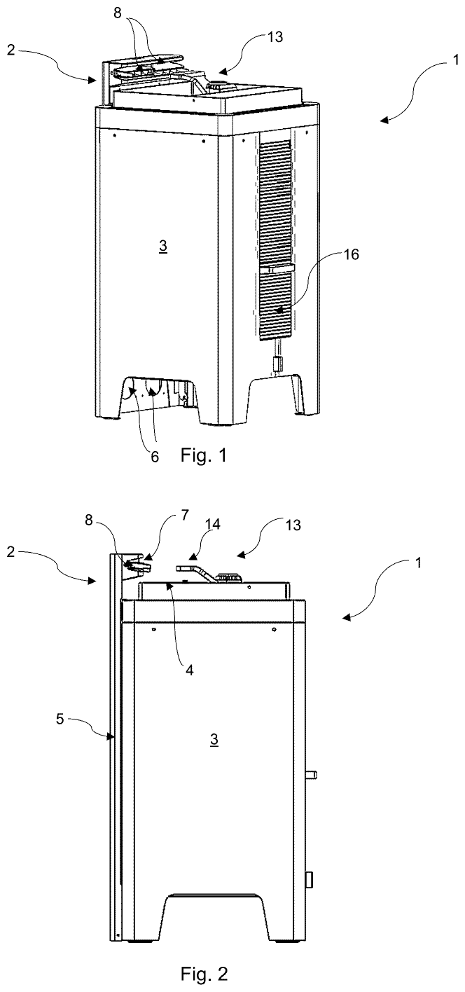

### DETAILED DESCRIPTION OF THE ENABLING EMBODIMENT

In the following figures, identical parts are provided with the same reference numerals. If a figure contains reference numerals which are not discussed in greater detail in the pertaining description of the figures, reference is made to preceding or following descriptions of the figures.

The figures show views of an embodiment of a sauna stove 1 according to the disclosure with a device 2 according to the disclosure for a sauna stove 1 for a sauna room. The sauna stove 1 has a housing 3 that contains a heating device of the sauna stove 1 and has a discharge opening 4 through which the air heated by the heating device exits from the housing 3. In the discharge opening 4, a bed of stones 17 shown in FIG. 6 is arranged and projects beyond the discharge opening 4. The device 2 has an air duct 5 which is arranged along an outer wall of the housing 3 and has two inlet openings 6 below and two outlet openings 7 above the housing 3. Fans are arranged each in the inlet openings 6, which are not shown in the figures, and draw the air from below the housing 3 into the air duct 5 of the device 2. From there, the air is guided through the air duct 5 to the two outlet openings 7 which are arranged just above the discharge opening 4 and are directed in the horizontal direction to the discharge opening 4. In each of the two outlet openings 7, a flow alignment component 8 is arranged which defines the direction of flow of the air from the outlet openings 7.

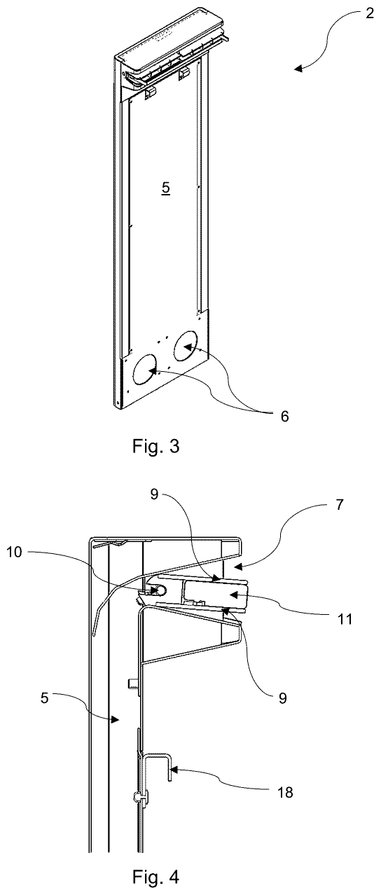

As shown in FIG. 3, the device 2 has at least one suspension 18 by which the device 2 is attached to the housing 3 of the sauna stove 1.

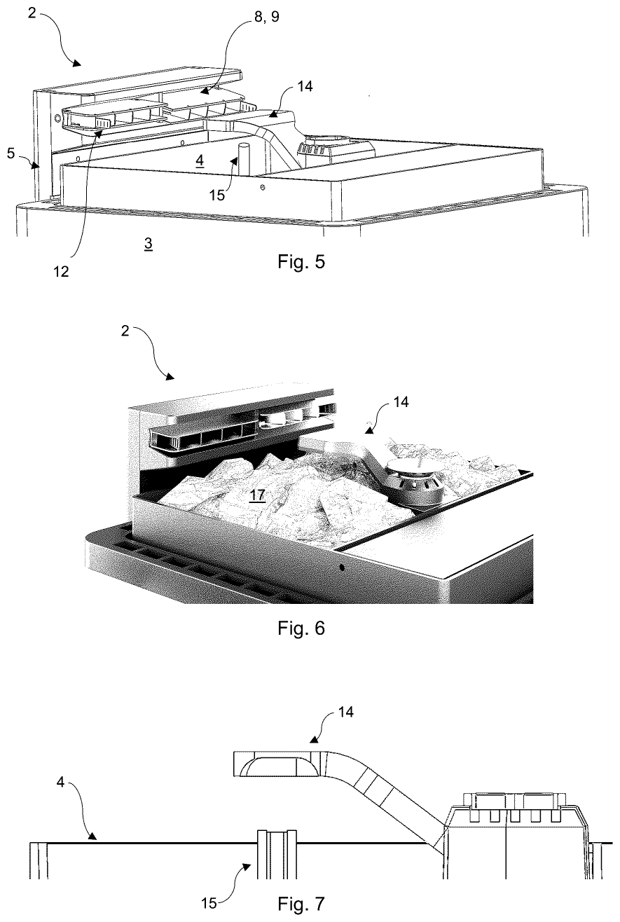

The functioning of the flow alignment component 8 is shown in FIGS. 4, 5 and 6. Here, the flow alignment components 8 each have two horizontal louvers 9 arranged one above the other in parallel which are fixed with respect to each other at a fixed distance from each other and which are mounted to rotate about a horizontal axis 10 in the respective outlet opening 7. The mounting is here designed such that the entire air flow that is passed through the air duct 5 is guided between the two horizontal louvers 9, wherein the air duct 5 is, before this transition, designed such that a preferably laminar air flow is achieved when the direction of movement is changed. By mounting the horizontal louvers 9 around the horizontal axis 10, the direction of flow of the air from the outlet openings can be adjusted in the vertical direction, wherein the vertical adjustment is limited by the further course of the outlet openings 7.

Between the horizontal louvers 9, four vertical louvers 11 are arranged which are each movable in a swiveling manner about an axis that is situated, parallel to a normal, on the two horizontal louvers 9. Here, the vertical louvers 11 are connected to each other in such a way that they are always aligned in parallel with respect to each other. By swiveling the vertical louver 11, the horizontal component of the direction of flow of the air from the outlet openings 7 can be adapted. Per flow alignment component 8, one vertical louver 11 each has a plastic clip 12 that can be grasped by the hand to align both the vertical and the horizontal directions of flow of the air from the outlet openings 7 by adapting the flow alignment component 8.

Apart from the housing 3 and the device 2, the embodiment of the sauna stove 1 shown in the figures has an automatic infusion device 13 which has a spray plate 14, a reservoir for infusion liquid, a pump and a line 15 with a liquid opening. The reservoir is arranged in a removable infusion tank 16, which is arranged to be easily accessible on a front side of the housing 3. The pump, which is spaced apart with the reservoir of the heating device of the special stove and is arranged in an insulated manner, pumps infusion liquid from the reservoir through the line 15 which passes through the bed of stones 17 to the liquid opening, which is arranged below the spray plate 14 such that infusion liquid is guided vertically from the liquid opening against the spray plate 14.

The spray plate 14 is curved to the bottom, which is particularly apparent in FIG. 7, such that the liquid can flow along this curvature and from there covers a large area of the bed of stones 17. Here, the curved bottom side of the spray plate 14 can include additional elements which cause a dripping off of the infusion liquid from the spray plate 14 at specified positions above the bed of stones 17.

The embodiment of the sauna stove 1 according to the disclosure has a control interface with buttons, and next to a voice control which are set up in such a way that a user of the sauna stove 1 can choose from different programs which can contain an infusion by means of the automatic infusion device with a selectable intensity, and/or the use of the device 2, also with an intensity selectable by the air flow from the outlet openings 7.

What is claimed is:

1. A device for a sauna stove for a sauna room which is configured to distribute air heated by the sauna stove above a housing of the sauna stove, which contains a heating device of the sauna stove, in a targeted manner in the sauna room and includes at least one fan, the device comprising:
an air duct with at least one inlet opening below the housing and at least one outlet opening above a discharge opening of the housing,
wherein the air heated by the heating device exits the housing through the discharge opening and in which preferably a bed of stones is arranged,
wherein the air duct and the fan are configured such that the fan draws air into the at least one inlet opening, then transports the air upwards in the air duct along the sauna stove to the at least one outlet opening, and blows the air out of the at least one outlet opening above the discharge opening of the housing of the sauna stove, and
wherein a flow alignment component is arranged at the outlet opening and is configured such that a direction of flow of the air is adjustable.

2. The device according to claim 1, wherein the direction of flow always has a horizontal component which leads from the outlet opening via the discharge opening of the housing into the sauna room.

3. The device according to claim 1, wherein the at least one outlet opening is arranged at a height of 2 to 20 cm above the discharge opening of the housing, wherein the at least one outlet opening is preferably arranged at a height of 1 to 15 cm above a highest point of a bed of stones situated in the discharge opening.

4. The device according to claim 3, wherein the at least one outlet opening is arranged at a height of 4 to 10 cm above the discharge opening of the housing.

5. The device according to claim 4, wherein the at least one outlet opening is arranged at a height of between 6 to 9 cm above the discharge opening of the housing.

6. The device according to claim 1, wherein the device is configured such that a volume flow of the air through the air duct is between 50 and 150 m³/h.

7. The device according to claim 6, wherein the volume flow of the air through the duct is between 80 to 120 m³/h.

8. The device according to claim 7, wherein the volume flow of the air through the duct is approximately 100 m³/h.

9. The device according to claim 1, wherein the device includes two outlet openings with one flow alignment component each, wherein the directions of flow from the two outlet openings through the respective flow alignment components are each adjustable independently.

10. The device according to claim 1, wherein the flow alignment component is designed such that both a vertical and a horizontal component of the direction of flow are adjustable.

11. The device according to claim 10, wherein the flow alignment component includes horizontal louvers and vertical louvers which are mounted to be movable with respect to each other and with respect to the outlet opening.

12. The device according to claim 11, wherein the flow alignment component includes two horizontal louvers arranged one upon the other in parallel which are rigidly connected with each other at their longitudinal ends and are mounted to be rotatable about an axis of rotation parallel to a longitudinal orientation of the horizontal louvers in the outlet opening, wherein the flow alignment component has at least two vertical louvers which are mounted between the horizontal louvers in a swiveling manner and are preferably connected to each other in such a way that, by adjusting one vertical louver, the other vertical louvers are aligned.

13. A sauna stove including a device according to claim 1 for a sauna room, wherein the device is attached to a first outer wall of a housing of the sauna stove containing a heating device and including a discharge opening from which the air heated by the heating device exits from the housing.

14. The sauna stove according to claim 13, further including a bed of stones which is arranged in the discharge opening, and an automatic infusion device which includes a reservoir, a pump and a liquid distribution means which are configured such that liquid from the reservoir is distributed onto the bed of stones by means of the pump and the liquid distribution means.

15. The sauna stove according to claim 13, further including a voice control by which the pump can be actuated, wherein the amount of the distributed liquid is adjustable by means of the voice control, and wherein the device can also be actuated by voice control.

16. The sauna stove according claim 13, further including a housing that contains a heating device and includes a discharge opening from which the air heated by the heating device exits due to convection, wherein the sauna stove includes a bed of stones which is arranged in the discharge opening, and an automatic infusion device which includes a reservoir, a pump and a liquid distribution means which are configured such that liquid from the reservoir is distributed onto the bed of stones by means of the pump and the liquid distribution means, wherein the liquid distribution means includes a spray plate and a liquid opening, wherein the liquid opening is arranged below the spray plate, surrounded by the bed of stones, such that liquid from the liquid opening is sprayable against the spray plate from below, and wherein the liquid opening is oriented such that the liquid exits from the latter vertically to the top.

17. The sauna stove according to claim 16, wherein the pump and the reservoir are arranged separately from the heating elements, and a line leads from the pump through the bed of stones to the liquid opening, wherein the reservoir, the pump and the line are preferably thermally insulated from the heating elements and the bed of stones.

18. The sauna stove according to claim 16, wherein a bottom side of the spray plate is curved to the bottom such that the occurring liquid is distributed over at least 30% of the bed of stones, wherein the bottom side of the spray plate has a honeycomb structure by which a dripping off of the liquid from the bottom side of the spray plate is caused at predetermined positions over the bed of stones.

19. The sauna stove according to claim 18, wherein the occurring liquid is distributed over at least 50% of the bed of stones.

20. The sauna stove according to claim 16, wherein the pump has a discharge height of at least 15 cm and maximally 45 cm, and the spray plate has a distance between 0.5 cm and 4 cm from the liquid opening.
